(19) United States
(12) Patent Application Publication
(10) Pub. No.: US 2014/0361654 A1
(43) Pub. Date: Dec. 11, 2014

(54) BRUSHLESS PERMANENT-MAGNET MOTOR

(71) Applicant: DURQ MACHINERY CORP., Taichung City (TW)

(72) Inventors: Chia-Sheng LIU, Taichung City (TW); Yi-Li ZHANG, Taichung City (TW)

(73) Assignee: DURQ MACHINERY CORP., Taichung City (TW)

(21) Appl. No.: 13/963,647

(22) Filed: Aug. 9, 2013

(30) Foreign Application Priority Data
Jun. 7, 2013 (TW) 102120405

(51) Int. Cl. H02K 1/14; H02K 1/27

(52) U.S. Cl. CPC H02K 1/146; H02K 1/274
USPC 310/156.12; 310/216.101

(57) ABSTRACT

A brushless permanent-magnet motor includes a rotor, a magnet set mounted at the rotor, a stator coaxially surrounding the magnet set in a coaxial manner relative to the rotor, and a bushing set between the magnet set and the stator in a coaxial manner relative to the rotor and the stator. The stator has a plurality of teeth spaced around the inner perimeter thereof and a retaining crevice defined between the distal front end portions of each two adjacent teeth remote from the inner perimeter. The bushing has a plurality of locating ribs respectively engaged into the retaining crevices of the stator. Thus, the brushless permanent-magnet motor has a high level of structural stability, and can effectively reduce the air-gap flux density variation and instant cogging torque and torque ripples and solve vibration and noise problems.

### BACKGROUND OF THE INVENTION

1. Field of the Invention

The present invention relates to brushless motor technology, and more particularly to a brushless permanent-magnet motor, which has a bushing set between the magnet set and stator thereof to enhance the structural stability and to effectively reduce the air-gap flux density variation and instant cogging torque and torque ripples and solve vibration and noise problems.

2. Description of the Related Art

When compared to conventional motors, a brushless permanent-magnet motor has the benefits of high performance and high torque density, and therefore brushless permanent-magnet motors are widely used in different driving systems, such as marine propeller, lawn mower, elevator traction machine, etc. However, commercial brushless permanent-magnet motors commonly have the drawback of high cogging torque due to a large gap between the teeth of the stator, lowering the motor performance. This problem becomes more serious under a low revolving speed, and can affect the normal functioning of the brushless permanent-magnet motor after a long time.

To solve the aforesaid drawback, an improved brushless permanent-magnet motor 5 was created, as shown in FIG. 1. According to this prior art design, the brushless permanent-magnet motor 5 comprises a stator 51 and a rotor 53. The stator 51 comprises a plurality of teeth 513 spaced around the inner perimeter 511 thereof, and a plurality of winding grooves 515 respectively defined between each two adjacent teeth 513 for enabling a winding to be wound thereon. The rotor 53 has a plurality of magnet components 55 reversely attached to the periphery thereof. The magnet components 55 are disposed between the teeth 511 of the stator 51 and the rotor 53. Thus, when a DC current is conducted to the winding, a rotating magnetic field is generated corresponding to each magnet component 55 at the rotor 53, causing the rotor 53 to rotate.

Subject to the design of the teeth of the stator in the aforesaid prior art brushless permanent-magnet motor, a small gap is defined between each two adjacent teeth. Therefore, when a DC current is conducted to the winding to create a rotating magnetic field, the magnetic flux density in the gap between each two adjacent teeth will be higher than that at the side of each tooth that faces toward the respective magnet component. However, when the longitudinal section of the connection between each two adjacent magnet component passes through the gap between the respective two adjacent teeth after startup of the brushless permanent-magnet motor, a magnetic field cutoff sound will be produced. Therefore, this prior art design cannot effectively eliminates the problem of high cogging torque due to a tooth gap and the problem of noises.

In conclusion, the prior art structures still have drawbacks, leaving room for improvement.

### SUMMARY OF THE INVENTION

The present invention has been accomplished under the circumstances in view. It is the main object of the present invention to provide a brushless permanent-magnet motor, which has a high level of structural stability, and can effectively reduce the air-gap flux density variation and instant cogging torque and torque ripples and solve vibration and noise problems.

To achieve this and other objects of the present invention, a brushless permanent-magnet motor of the invention comprises a rotor, a magnet set, a stator and a bushing. The magnet set is mounted around the rotor. The stator surrounds the rotor and the magnet set in a coaxial manner relative to the rotor, comprising an inner perimeter, a plurality of teeth spaced around the inner perimeter and a winding groove defined between each two adjacent the teeth for enabling a winding to be wound on each tooth. Each tooth has a front end portion disposed remote from the inner perimeter. The stator further comprises a plurality of retaining crevices respectively defined between the front end portions of each two adjacent the teeth. The bushing comprises a thin wall, and a plurality of locating ribs located at the thin wall corresponding to the retaining crevice between the front end portions of each two adjacent the teeth. Each locating rib is engaged into one retaining groove between the front end portions of two adjacent the teeth. The bushing is disposed in a coaxial manner relative to the rotor and the stator, and set between the magnet set and the stator.

Preferably, the bushing further comprises a plurality of holes located at the thin wall.

Preferably, each hole of the bushing is located at one respective the locating rib.

Preferably, the holes of the bushing are equally spaced around the thin wall.

Preferably, the bushing is configured in a circular or polygonal shape.

Further, the rotor comprises an outer perimeter, and a plurality of insertion grooves located at and spaced around the outer perimeter. The magnet set comprises a plurality of magnet components respectively engaged into the insertion grooves of the rotor.

Further, each insertion groove of the rotor defines a first accommodation space and a second accommodation space arranged in direction from the rotor toward the stator. Further, the volume of the first accommodation space is larger than the volume of the second accommodation space.

Further, each magnet component comprises an outer arc surface, an inner arc surface, two opposite lateral sides and a flange located at each lateral side adjacent to the inner arc surface for enabling each magnet component to be engaged into the first accommodation space and second accommodation space of one respective insertion groove of the rotor.

Thus, by means of increasing the inner diameter of the stator for accommodating the bushing without changing the configuration of the rotor and engaging the locating ribs of the bushing into the respective retaining crevices of the stator, the invention effectively reduces the air-gap flux density variation and instant cogging torque and torque ripples and solves vibration and noise problems.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic sectional view of a brushless permanent-magnet motor according to the prior art.

FIG. 2 is a schematic sectional view of a brushless permanent-magnet motor in accordance with a first embodiment of the present invention, illustrating the relative positioning of respective components.

FIG. 3 is an exploded view of the brushless permanent-magnet motor in accordance with the first embodiment of the present invention.

FIG. 4 is a magnetic flux density curve obtained from the brushless permanent-magnet motor in accordance with the first embodiment of the present invention.

FIG. 5 is a cogging torque curve obtained from the brushless permanent-magnet motor in accordance with the first embodiment of the present invention.

FIG. 6 is a schematic sectional view of a brushless permanent-magnet motor in accordance with a second embodiment of the present invention, illustrating the relative positioning of respective components.

FIG. 7 is a magnetic flux density curve obtained from the brushless permanent-magnet motor in accordance with the second embodiment of the present invention.

FIG. 8 is a cogging torque curve obtained from the brushless permanent-magnet motor in accordance with the second embodiment of the present invention.

FIG. 9 is a schematic sectional view of a brushless permanent-magnet motor in accordance with a third embodiment of the present invention, illustrating the relative positioning of respective components.

FIG. 10 is an exploded view of the brushless permanent-magnet motor in accordance with the third embodiment of the present invention.

FIG. 11 is a magnetic flux density curve obtained from the brushless permanent-magnet motor in accordance with the third embodiment of the present invention.

FIG. 12 is a cogging torque curve obtained from the brushless permanent-magnet motor in accordance with the third embodiment of the present invention.

FIG 13 is a schematic sectional view of a brushless permanent-magnet motor without bushing in accordance with a fourth embodiment of the present invention, illustrating the relative positioning of respective components. FIG. 14 is a magnetic flux density curve obtained from the brushless permanent-magnet motor in accordance with the fourth embodiment of the present invention.

FIG. 15 is a cogging torque curve obtained from the brushless permanent-magnet motor in accordance with the fourth embodiment of the present invention.

FIG. 16 is a cogging torque curve comparative chart obtained from the four embodiments of the present invention.

FIG. 17 is an electromagnetic torque curve comparative chart obtained from the four embodiments of the present invention under the rated speed of revolution.

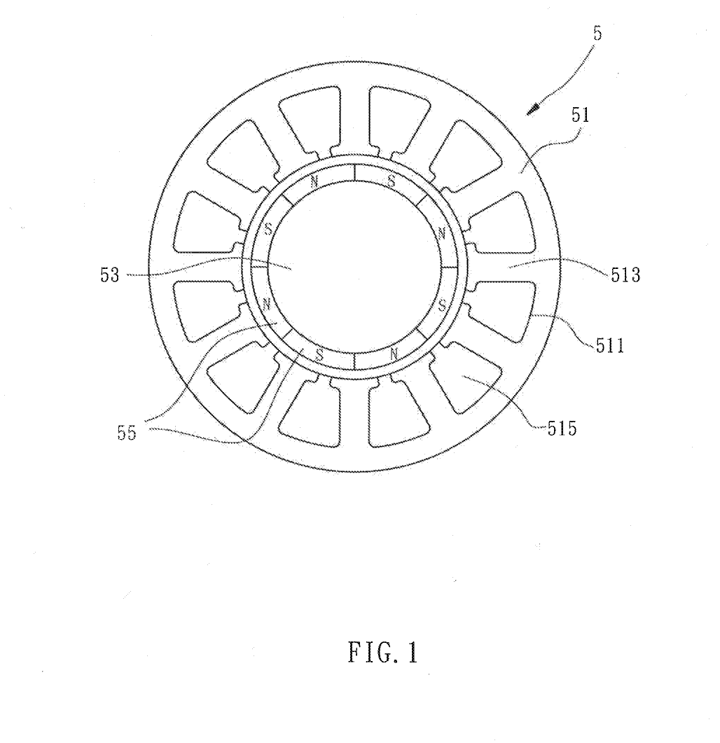

### DETAILED DESCRIPTION OF THE INVENTION

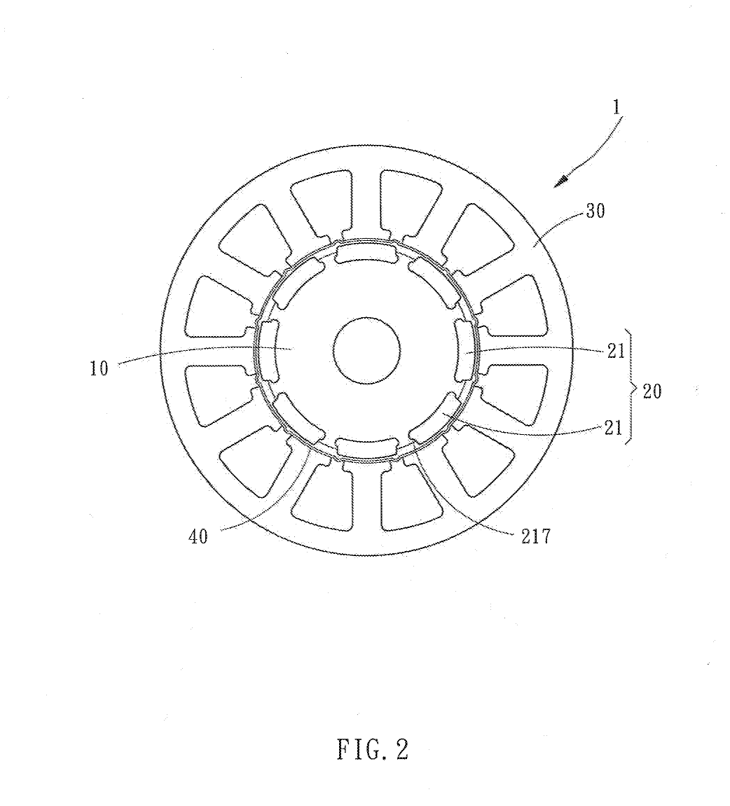

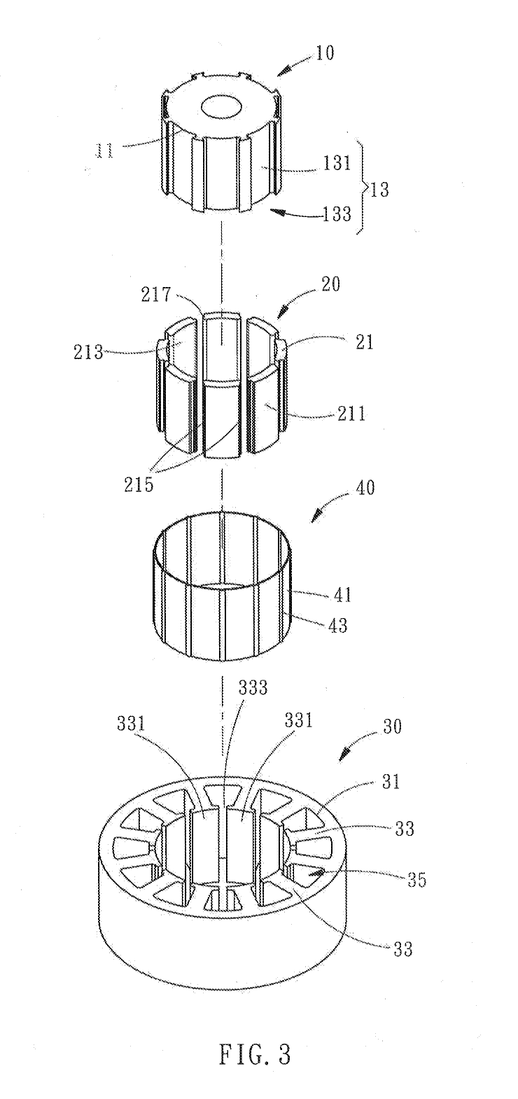

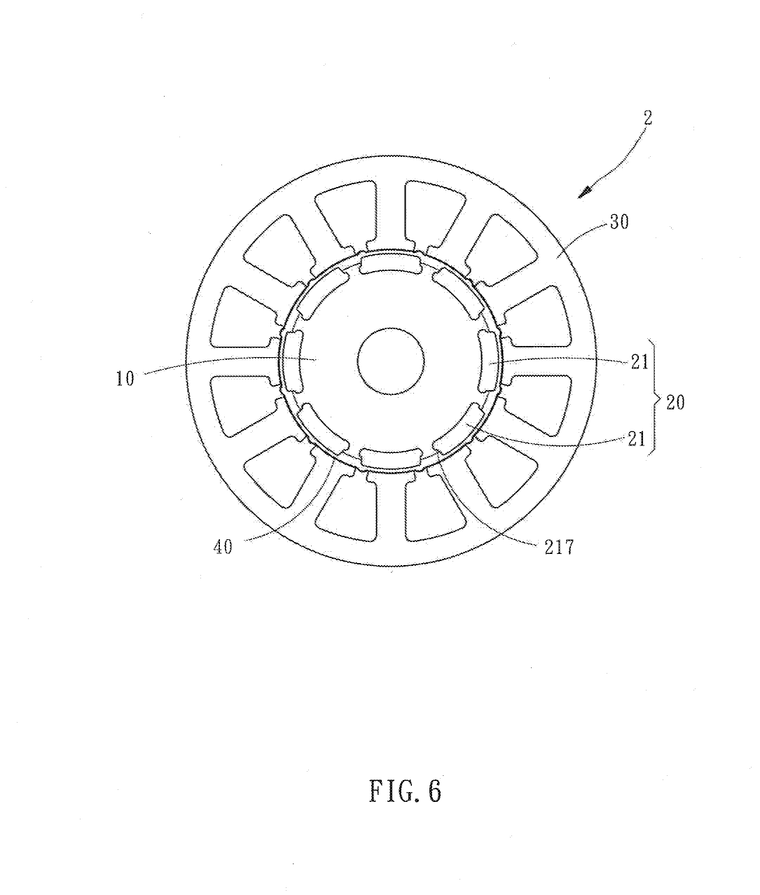

Referring to FIGS. 2, 3 and 6, a brushless permanent-magnet motor 1, 2 in accordance with first and second embodiments of the present invention is shown. The brushless permanent-magnet motor 1, 2 comprises a rotor 10, a magnet set 20, a stator 30, and a bushing 40.

The rotor 10 comprises an outer perimeter 11, and a plurality of insertion grooves 13 located at and spaced around the outer perimeter 11. Each insertion groove 13 defines a first accommodation space 131 and a second accommodation space 133 arranged in direction from the rotor 10 toward the stator 30. Further, the volume of the first accommodation space 131 is larger than the volume of the second accommodation space 133.

The magnet set 20 comprises a plurality of magnet components 21. Each magnet component 21 defines an outer arc surface 211, an opposing inner arc surface 213, two opposing lateral sides 215, and a flange 217 located at each lateral side 215 adjacent to the inner arc surface 213. Thus, the magnet components 21 can be stably inserted into the first accommodation spaces 131 and second accommodation spaces 133 of the respective insertion grooves 13 and positioned in the outer perimeter 11 of the rotor 10. The mounting structure between the rotor 10 and the magnet set 20 eliminates the problem of using an adhesive to bond the magnet set 20 to the outer perimeter 11 of the rotor 10 that the applied adhesive will have deteriorated after a long use, causing the magnet set 20 to drop from the rotor 10 due to the effect of centrifugal force upon a high speed rotation and leading to brushless permanent-magnet motor failure.

The stator 30 surrounds the rotor 10 and the magnet set 20 in a coaxial manner relative to the rotor 10. Further, the stator 30 comprises an inner perimeter 31, a plurality of teeth 33 spaced around the inner perimeter 31, and a winding groove 35 defined between each two adjacent teeth 33 for enabling a winding to be wound on each tooth 33 and positioned in each winding groove 35. Each tooth 33 has a front end portion 331 disposed remote from the inner perimeter 31. Further, a retaining crevice 33 is defined between the front end portions 331 of each two adjacent teeth 33.

The bushing 40 comprises a thin wall 41, and a plurality of locating ribs 43 protruded from the periphery of the thin wall 41. By means of engaging the locating ribs 43 of the bushing 40 into the respective retaining crevices 333 the stator 30, the thin wall 41 is set between the magnet set 20 and the stator 30 and kept in a coaxial manner relative to the rotor 10 and the stator 30. Further, the bushing 40 in accordance with the first and second embodiments of the present invention can be configured having a circular or polygonal shape; the thickness of the thin wall 41 of the bushing 40 is 1 mm in the first embodiment, or 0.5 mm in the second embodiment.

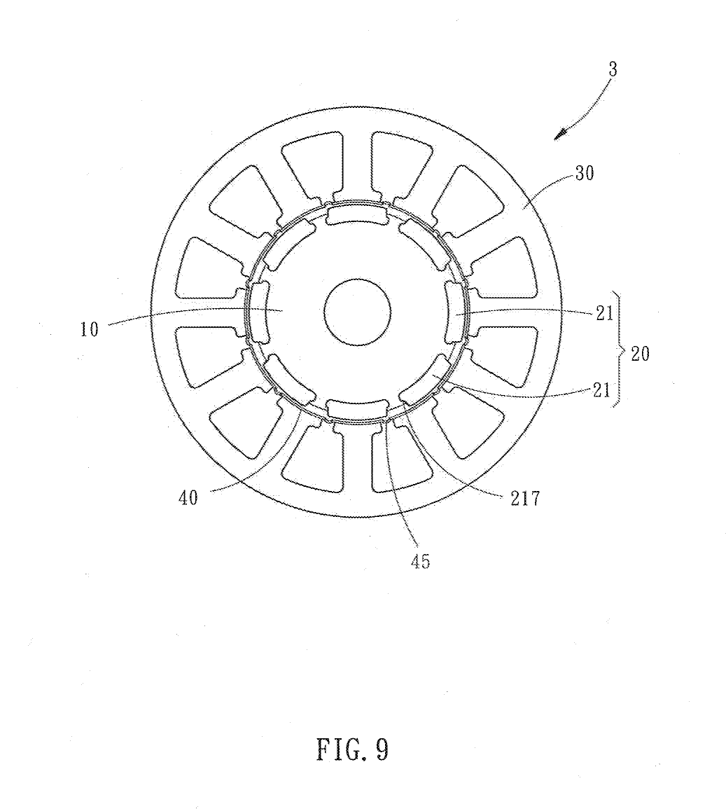

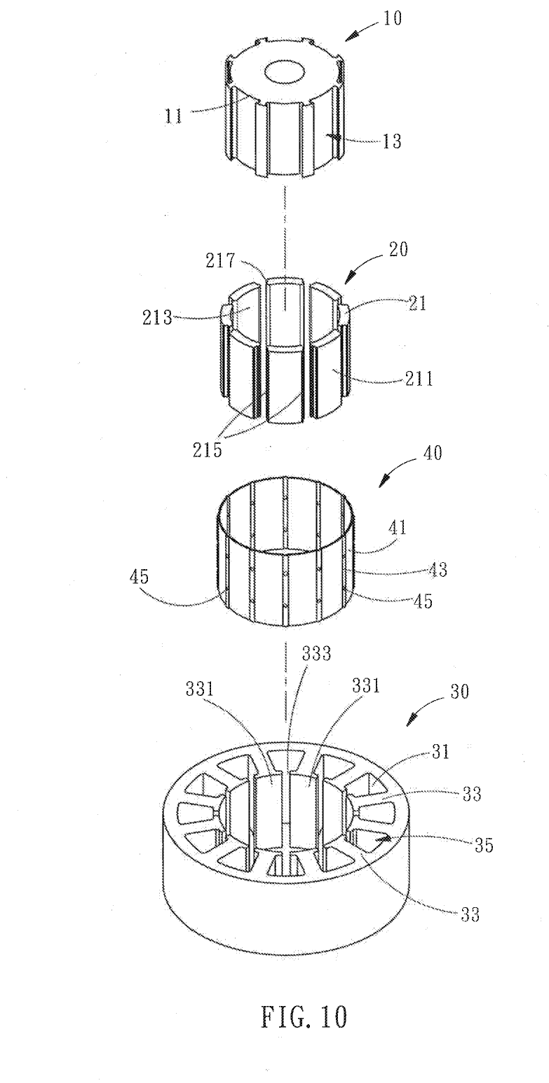

Referring to FIG. 9, a brushless permanent-magnet motor 3 in accordance with a third embodiment of the present invention is shown. This third embodiment is substantially similar to the aforesaid first and second embodiments with the exception that the bushing 40 of the brushless permanent-magnet motor 3 in accordance with this third embodiment comprises a plurality of holes 45 located at the locating ribs 43 and equally spaced around the thin wall 41.

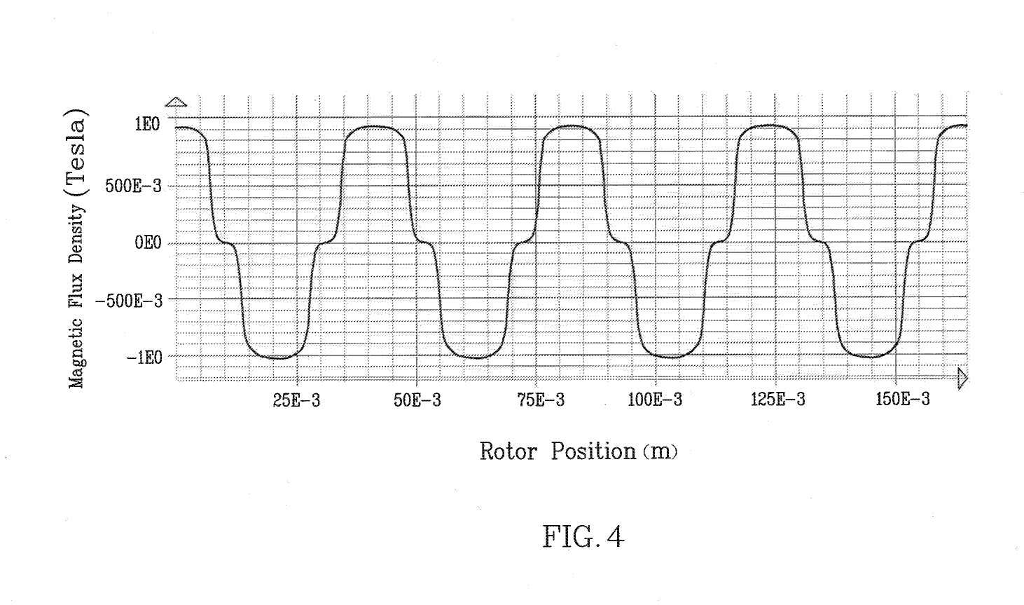

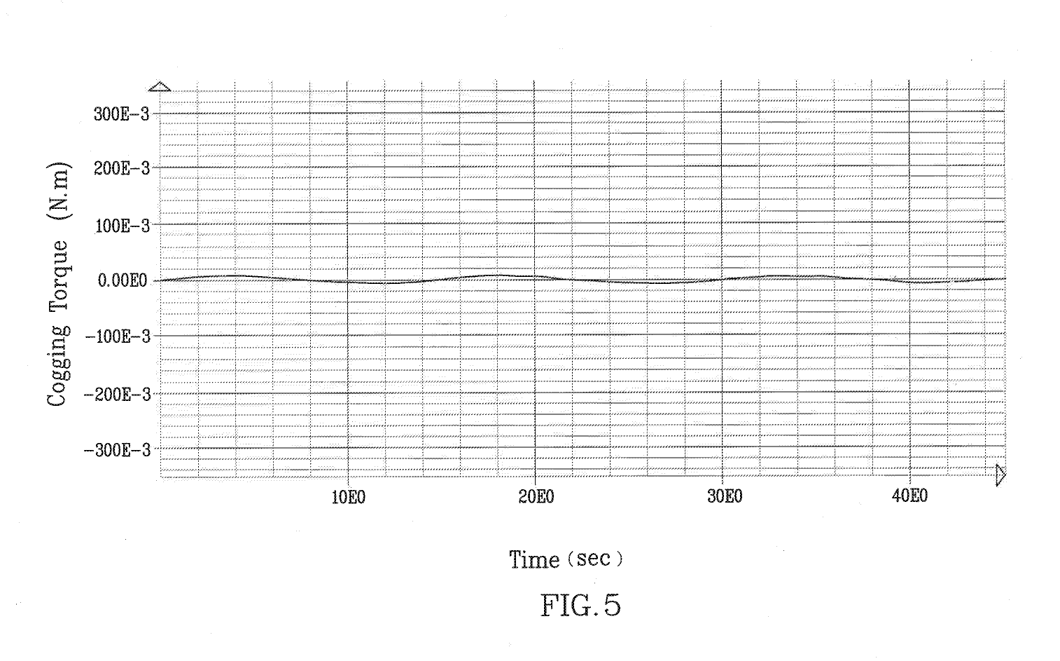

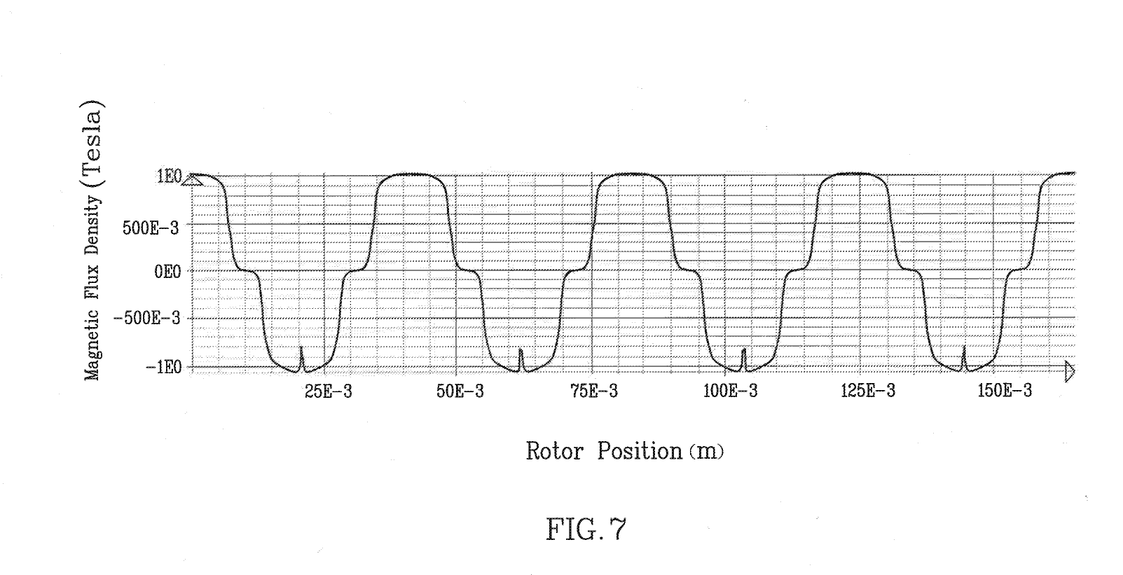

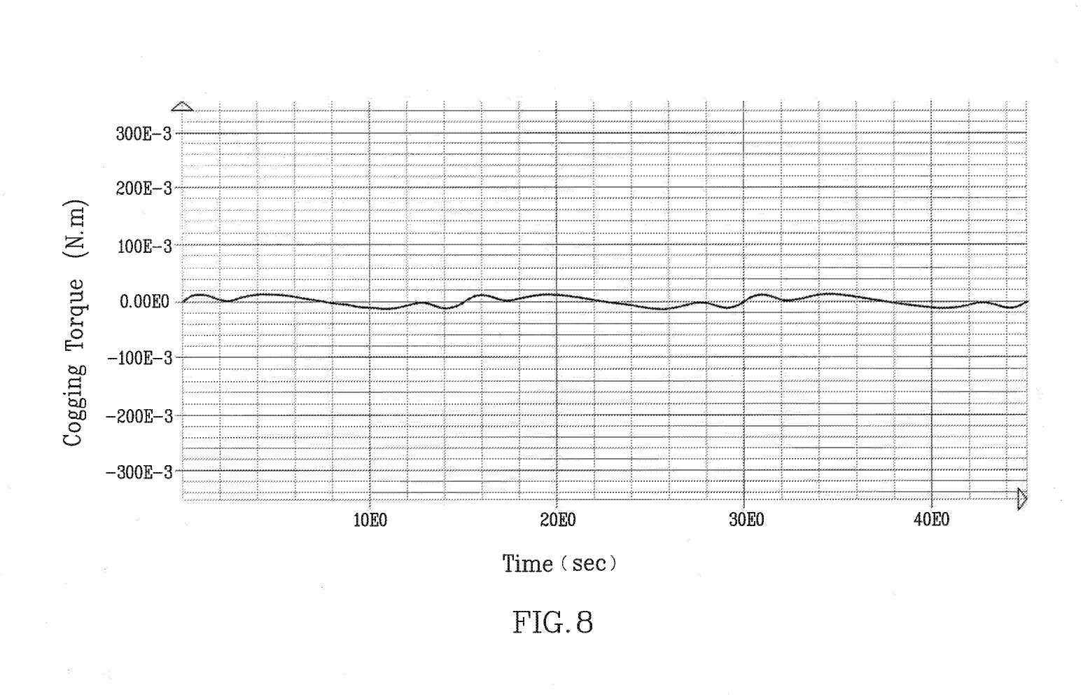

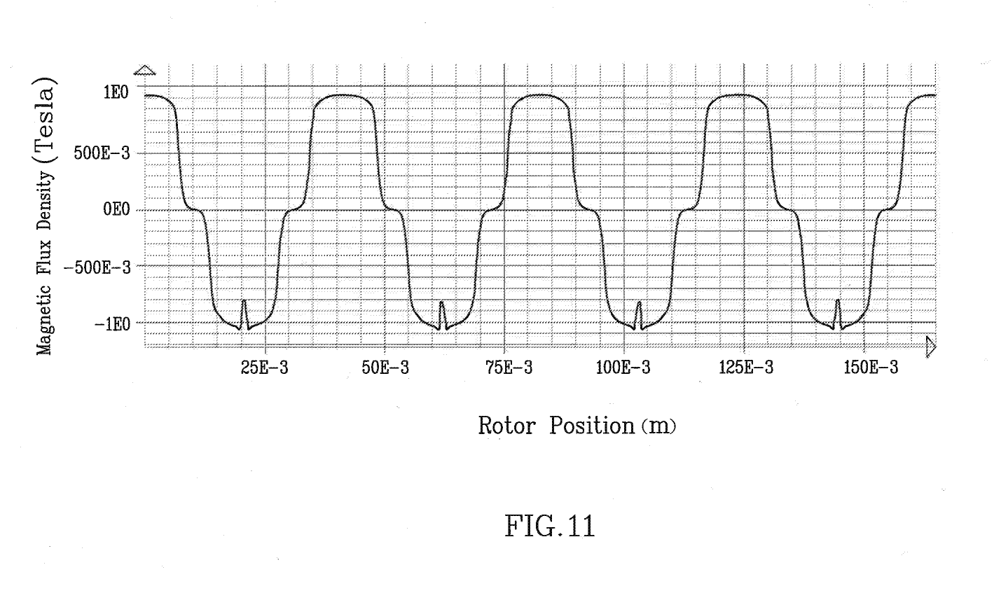

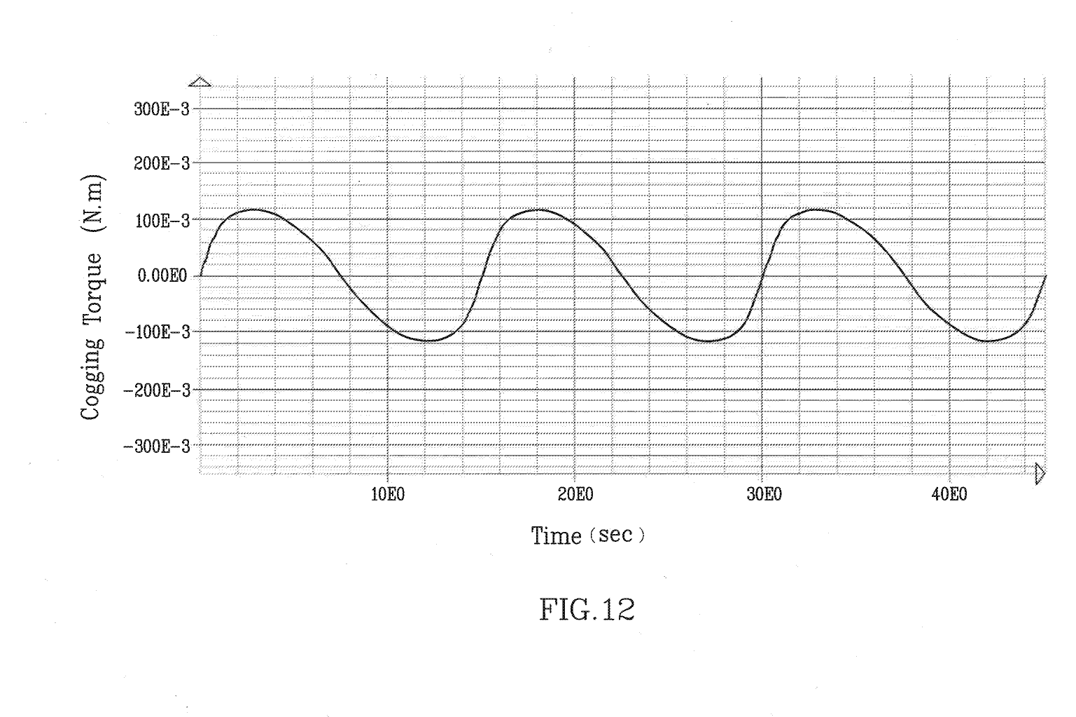

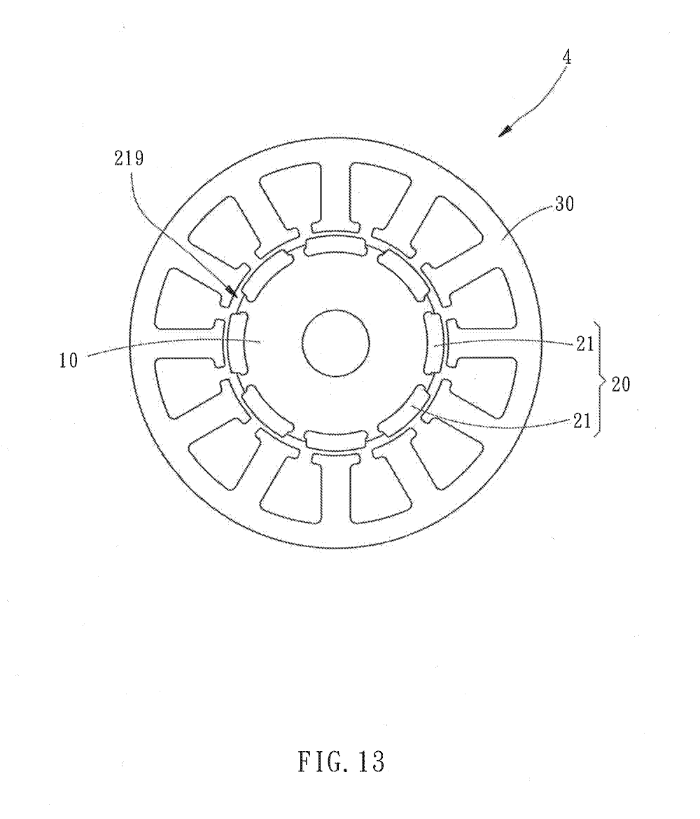

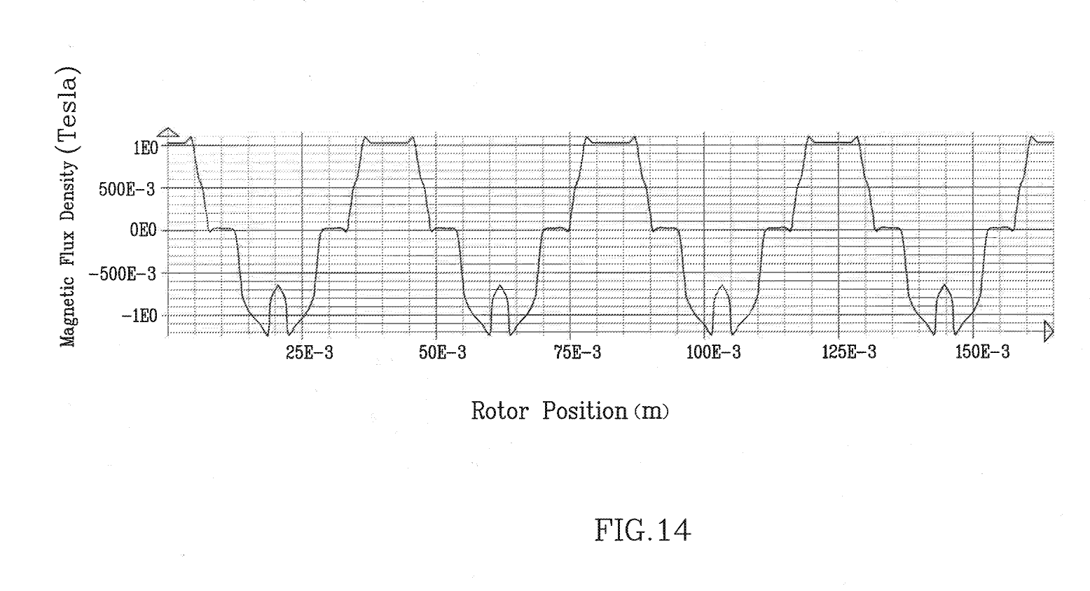

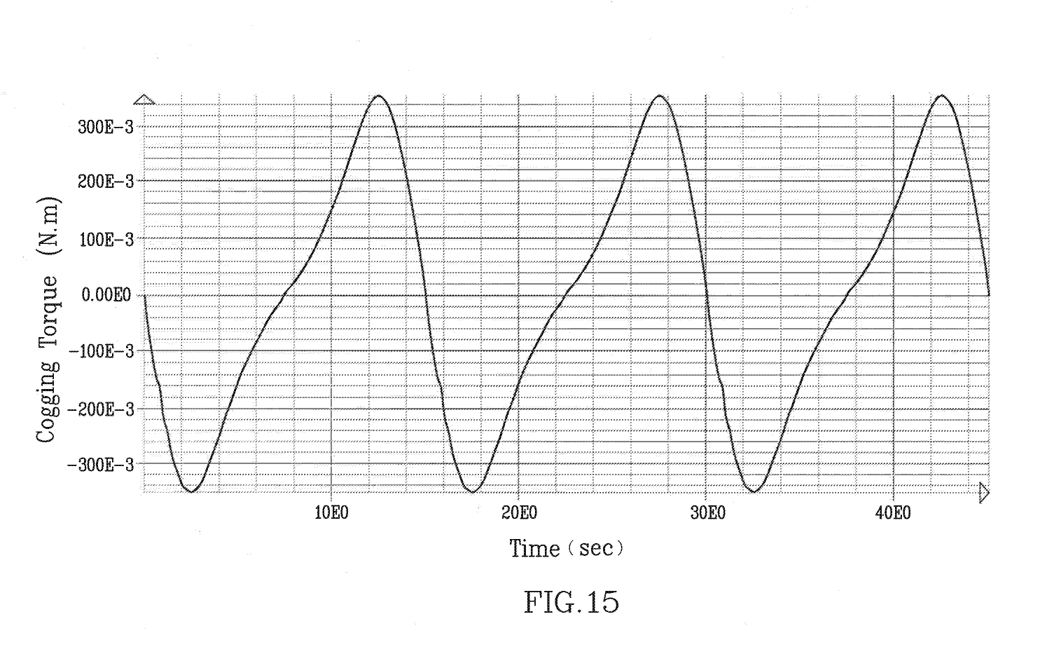

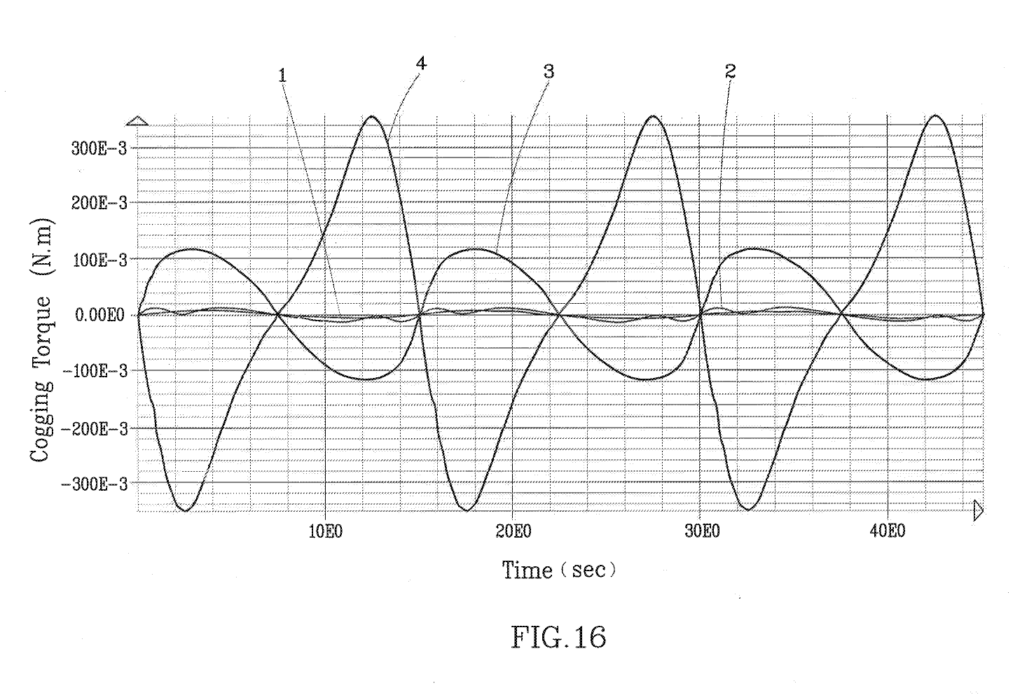

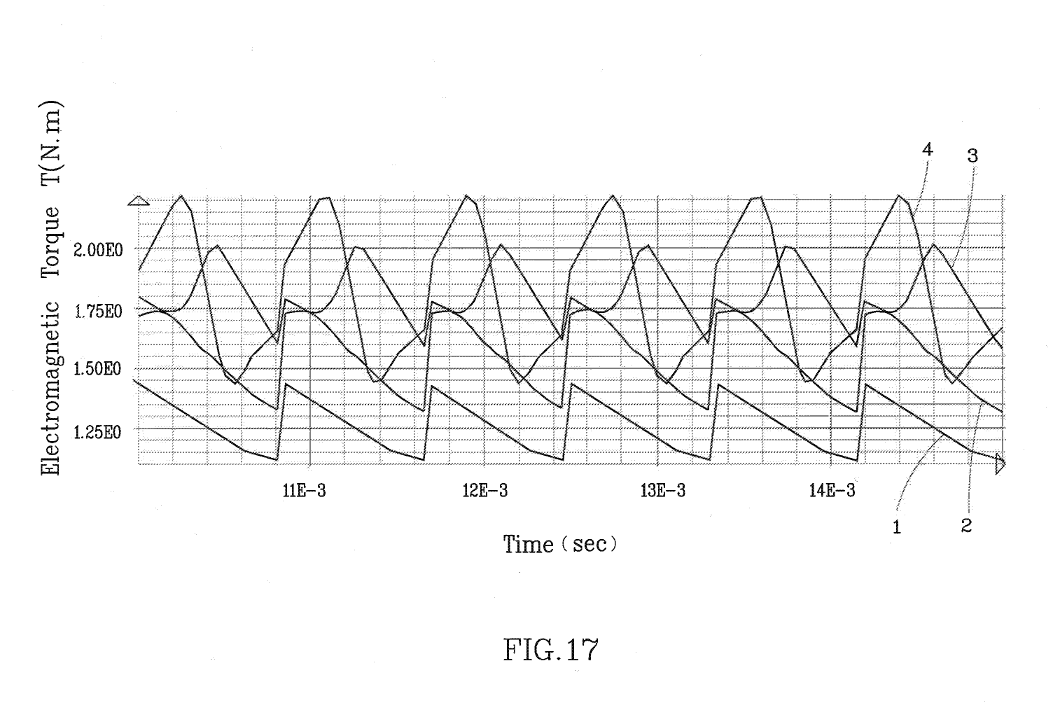

In order to more clearly state the effect of the present invention, a brushless permanent-magnet motor 4 in accordance with a fourth embodiment of the present invention is shown in FIG. 13. This fourth embodiment is substantially similar to the aforesaid first embodiment with the exception that it eliminates the use of the bushing 40 between the rotor 10 and the stator 30. Referring to FIGS. 4, 7, 11 and 14, magnetic flux density curves obtained from the first, second third and fourth embodiments of the invention are illustrated. As illustrated, the use of the bushing 40 in the brushless permanent-magnet motor smoothens the magnetic flux density curves. More particularly in the application of the first embodiment, the curve rises and balls in a conical manner. In the fourth embodiment, a recess 219 is defined between each two adjacent magnet components 21, causing a significant transient variation in the magnetic flux density in front of each two adjacent magnet components 21, and thus the curve shown in FIG. 14 exhibits a trapezoidal configuration. Further, the formation of the recess 219 causes an instant increase in air gap between the rotor 10 and the stator 30, resulting in an increase in cogging torque and generation of vibrations and noises. Further, cogging torque curves obtained from the first, second, third and fourth embodiments of the present invention are illustrated in FIGS. 5, 8, 12 and 15. As illustrated, the use of the e bushing 40 in the brushless permanent-magnet motor significantly smoothens the cogging torque curve, more particularly the cogging torque curves obtained from the first and second embodiments are close to a smooth line. Further, in FIGS. 16 and 17, changing the thickness of the hushing 40 or the size of the holes 45 at the locating ribs 43 can adjust the cogging torque and the electromagnetic torque. For example, when compared to the fourth embodiment, the hole 45 at each locating rib 43 of the bushing 40 in the third embodiment makes the cogging torque and the electromagnetic torque under the rated speed of revolution slow down. Further, the wall thickness of the bushing 40 of the first embodiment is larger than the wall thickness of the bushing 40 of the second embodiment, and thus the cogging torque curved obtained from the first embodiment is more smoothened than that obtained from the second embodiment. Further, under the rated speed of revolution, the electromagnetic torque of the first embodiment is lower than the second embodiment, saving much power.

In general, the brushless permanent-magnet motor of the present invention has the advantages and features as follows:

1. Subject to the installation of the hushing 40 in between the rotor 10 and the stator 30, the invention not only can reduce the air-gap flux density variation and instant cogging torque but also solve vibration and noise problems.

2. The stator 30 defines a retaining crevice 333 between the front end portions 331 of each two adjacent teeth 33 thereof for receiving each respective locating rib 43 of the bushing 40, facilitating the installation of the brushless permanent-magnet motor and enhancing its structural stability.

3. By means of changing the thickness of the bushing 40 or the size of the hole 45 at each locating rib 43, the cogging torque and the electromagnetic torque under the rated speed of revolution are relatively adjusted.

4. The invention uses an engagement structure to secure the rotor 10 and the magnet set 20 together, preventing separation of the magnet set 20 from the rotor 10 and further brushless permanent-magnet motor failure due to the effect of high temperature and high revolving speed.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A brushless permanent-magnet motor, comprising:
a rotor;
a magnet set mounted around said rotor;
a stator surrounding said rotor and said magnet set in a coaxial manner relative to said rotor, said stator comprising an inner perimeter, a plurality of teeth spaced around said inner perimeter and a winding groove defined between each two adjacent said teeth for enabling a winding to be wound on each said tooth, each said tooth having a front end portion disposed remote from said inner perimeter, and a retaining crevice defined between the front end portions of each two adjacent said teeth; and
a bushing comprising a thin wall and a plurality of locating ribs located at said thin wall corresponding to the retaining crevice between the front end portions of each two adjacent said teeth, each said locating rib being engaged into one retaining groove between the front end portions of two adjacent said teeth, said bushing being disposed in a coaxial manner relative to said rotor and said stator and set between said magnet set and said stator.

2. The brushless permanent-magnet motor as claimed in claim 1, wherein said bushing further comprises a plurality of holes located at said thin wall.

3. The brushless permanent-magnet motor as claimed in claim 2, wherein each said hole is located at one respective said locating rib.

4. The brushless permanent-magnet motor as claimed in any one of claims 3, wherein said holes are equally spaced around said thin wall.

5. The brushless permanent-magnet motor as claimed in any one of claims 2, wherein said holes are equally spaced around said thin wall.

6. The brushless permanent-magnet motor as claimed in claim 1, wherein said bushing is configured in a circular or polygonal shape.

7. The brushless permanent-magnet motor as claimed in claim 1, wherein said rotor comprises an outer perimeter and a plurality of insertion grooves located at and spaced around said outer perimeter; said magnet set comprises a plurality of magnet components respectively engaged into said insertion grooves of said rotor.

8. The brushless permanent-magnet motor as claimed in claim 7, wherein each said insertion groove defines a first accommodation space and a second accommodation space arranged in direction from said rotor toward said stator, the volume of said first accommodation space being larger than the volume of said second accommodation space.

9. The brushless permanent-magnet motor as claimed in claim 8, wherein each said magnet component comprises an outer arc surface, an inner arc surface, two opposite lateral sides and a flange located at each said lateral side adjacent to said inner arc surface for enabling each said magnet component to be engaged into the first accommodation space and second accommodation space of one respective insertion groove of said rotor.
